(19) United States
(12) Patent Application Publication
(10) Pub. No.: US 2026/0253091 A1
(43) Pub. Date: Aug. 27, 2026

(54) PHOSPHOR-BASED AUTHENTICATION SYSTEM FOR MERCHANDISE AND BRAND PROTECTION

(71) Applicant: INTELLIGENT MATERIAL SOLUTIONS, INC., Princeton, NJ (US)

(72) Inventors: Joshua E. Collins, Wallingford, PA (US); Sean Morey, Princeton, NJ (US); Joshua T. Stecher, Trenton, NJ (US); Howard Y. Bell, Princeton, NJ (US); John Wolfe, Princeton, NJ (US); Viva Bell, Princeotn, NJ (US)

(73) Assignee: INTELLIGENT MATERIAL SOLUTIONS, INC., Princeton, NJ (US)

(21) Appl. No.: 19/551,974

(22) Filed: Feb. 27, 2026

Related U.S. Application Data
(60) Provisional application No. 63/764,287, filed on Feb. 27, 2025.

(51) Int. Cl. G06Q 30/018; G06Q 20/38

(52) U.S. Cl. CPC G06Q 30/0185; G06Q 20/389; G06Q 2220/00

(57) ABSTRACT

An authentication system comprises at least two excitation sources including an ultraviolet (UV) excitation source and an infrared (IR) excitation source, an authentication material disposed on or in an article, the authentication material comprising two or more phosphors, a detector configured to detect light emitted from the authentication material in response to excitation by the UV excitation source and the IR excitation source, and one or more processors operably coupled to the detector. The one or more processors are configured to determine authenticity of the article based on at least two of: (i) chromaticity response of the emitted light, (ii) spectral response of the emitted light, and (iii) temporal response of the emitted light.

### CROSS-REFERENCE TO RELATED APPLICATIONS

This application claims priority to U.S. Application No. 63/764,287, titled “PHOSPHOR-BASED AUTHENTICATION SYSTEM FOR SPORTS MERCHANDISE, BRANDING, AND CORPORATE IDENTITY PROTECTION”, filed Feb. 27, 2025, which is hereby incorporated by reference in its entirety.

### TECHNICAL FIELD

The present disclosure relates to authentication and anti-counterfeiting systems, and more particularly to systems and methods for authenticating merchandise, branded goods, identity documents, and packaging using photoluminescent materials including upconverting and downconverting phosphors, and verifying authenticity using spectral, chromaticity, and temporal response characteristics.

### BACKGROUND

Counterfeit merchandise and counterfeit branded products represent a growing problem that results in financial losses and brand dilution across numerous industries. Counterfeit sports merchandise and collectibles represent a particularly damaging segment, where consumers often rely on limited or easily replicated authentication methods. Traditional authentication approaches include holograms, printed labels, and QR codes. However, these approaches can be reproduced or simulated with increasing sophistication by counterfeiters, thereby reducing their effectiveness as anti-counterfeiting measures.

Authentication systems for branded products may benefit from multiple characteristics. For example, a robust authentication solution may be difficult to replicate, may provide fast and convenient verification, and may support multiple verification channels. Such verification channels may include consumer-level verification, such as smartphone-based verification, and forensic verification, such as time-gated or spectral analysis. Additionally, authentication events may be logged to create an auditable chain of custody for tracking purposes.

Photoluminescent materials, including phosphors, have been used in various applications due to their ability to absorb excitation energy at one wavelength and emit light at different wavelengths. Upconverting phosphors absorb longer wavelength excitation, such as infrared light, and emit shorter wavelength light, such as visible light. Downconverting phosphors absorb shorter wavelength excitation, such as ultraviolet light, and emit longer wavelength light, such as visible light. The emission characteristics of phosphors, including their spectral profiles, chromaticity coordinates, and temporal decay behavior, depend on material composition, dopant concentrations, and crystal structure.

Accordingly, improved systems and methods are desired for authentication of branded products, sports merchandise, and identity-related articles.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, an authentication system may be provided. The authentication system may include at least two excitation sources including an ultraviolet (UV) excitation source and an infrared (IR) excitation source. The authentication system may include an authentication material disposed on or in an article. The authentication material may include two or more phosphors. The authentication system may include a detector configured to detect light emitted from the authentication material in response to excitation by the UV excitation source and the IR excitation source. The authentication system may include one or more processors operably coupled to the detector. The one or more processors may be configured to determine authenticity of the article based on at least two of: (i) chromaticity response of the emitted light, (ii) spectral response of the emitted light, and (iii) temporal response of the emitted light.

In some aspects, the authentication system may include one or more of the following features. The authentication material may include at least one upconverting phosphor and at least one downconverting phosphor. The temporal response may include a luminescence decay lifetime. The one or more processors may be configured to determine authenticity based on whether the luminescence decay lifetime matches a stored reference lifetime. The one or more processors may be configured to determine authenticity based on whether the chromaticity response matches a predetermined brand chromaticity within a tolerance threshold. The tolerance threshold may be expressed as a ΔE threshold in CIELAB color space. The IR excitation source may include a first IR excitation source configured to emit approximately 800 nm light and a second IR excitation source configured to emit approximately 940 nm light. The UV excitation source may include a UV LED or laser diode configured to emit approximately 365 nm light. The detector may include a smartphone camera. The detector may include one or more photodiodes and one or more optical filters. The one or more processors may be configured to authenticate the article using a challenge-response excitation sequence including excitation at two or more different wavelengths. The challenge-response excitation sequence may include excitation using the UV excitation source, the IR excitation source at a first wavelength, and the IR excitation source at a second wavelength. The authentication material may include an overt emission feature and a covert emission feature. The authentication material may further include a forensic nanocrystal marker configured to emit a signal distinct from a brand-color emission signal. The article may include an identifier selected from the group consisting of a serial number, a QR code, an NFC tag, and an RFID tag. The one or more processors may be configured to associate the identifier with an emission signature. The one or more processors may be configured to log an authentication event to a blockchain.

In some aspects, a method of authenticating an article may be provided. The method may include applying an authentication material including two or more phosphors to the article. The method may include exciting the authentication material using an ultraviolet (UV) excitation source and an infrared (IR) excitation source. The method may include detecting emitted light from the authentication material using a detector. The method may include computing at least two authentication features including a chromaticity feature and a temporal feature. The method may include determining whether the article is authentic based on a comparison of the at least two authentication features to stored reference values.

In some aspects, the method may include one or more of the following features. The method may further include logging an authentication event including the at least two authentication features to a blockchain. Exciting the authentication material may include performing a challenge-response excitation sequence using two or more excitation wavelengths. The article may be sports merchandise or branded corporate merchandise. The authentication material may be embedded in a textile, printed on packaging, or disposed on a hangtag.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of an authentication system, according to aspects of the present disclosure.

FIG. 2A illustrates a cutaway isometric view of a layered authentication material, according to aspects of the present disclosure.

FIG. 2B illustrates an isometric view of an authentication material with a combined layer disposed on a substrate, according to aspects of the present disclosure.

FIG. 3 illustrates a flowchart for a challenge-response protocol, according to aspects of the present disclosure.

FIG. 4 illustrates a flowchart for a smartphone-based authentication workflow, according to aspects of the present disclosure.

FIG. 5A illustrates an isometric view of a compact reader device, according to aspects of the present disclosure.

FIG. 5B illustrates a block diagram of the compact reader device of FIG. 5A, according to aspects of the present disclosure.

FIG. 6A illustrates a flowchart for an authentication scoring method, according to aspects of the present disclosure.

FIG. 6B illustrates a flowchart for an authentication scoring process with a dual-threshold approach, according to aspects of the present disclosure.

FIG. 7A illustrates a front view of an article configured with a layered authentication material, according to aspects of the present disclosure.

FIG. 7B illustrates a section view of a tamper evident seal incorporating a layered authentication material structure, according to aspects of the present disclosure.

FIG. 7C illustrates a front view of a textile article with authentication material applied thereto, according to aspects of the present disclosure.

FIG. 7D illustrates a front view of an identity card incorporating authentication material, according to aspects of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

While authentication systems exist, there remains a need for authentication systems that provide robust protection against counterfeiting while supporting multiple verification channels. Existing authentication methods such as holograms, printed labels, and QR codes can be reproduced or simulated with increasing sophistication, rendering them insufficient for reliable verification of branded merchandise and identity documents. Current approaches often fail to provide multi-factor authentication that combines multiple emission characteristics, such as chromaticity, spectral profile, and temporal decay behavior, which are inherently difficult to replicate due to their dependence on precise material composition, dopant concentrations, and crystal structure. Furthermore, existing systems may lack the flexibility to support both consumer-level verification using readily available devices such as smartphones and forensic-level verification using specialized equipment. Therefore, there is an unmet need for an authentication system that leverages photoluminescent materials, including upconverting and downconverting phosphors, to provide multi-dimensional security through emission signatures that are difficult to counterfeit, while enabling verification across multiple channels and supporting auditable chain-of-custody tracking through secure logging mechanisms.

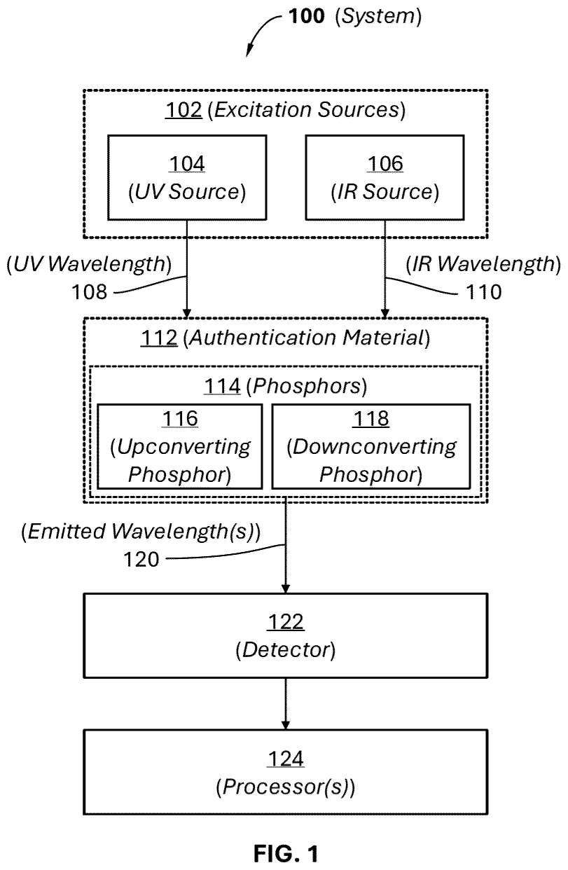

Referring to FIG. 1, an authentication system 100 may be configured to authenticate merchandise, branded goods, identity documents, and packaging using photoluminescent materials. The authentication system 100 may provide multi-dimensional security by generating emission profiles that match brand-specific colors when the photoluminescent materials are excited by appropriate excitation wavelengths. The authentication system 100 may be applied to professional sports merchandise across leagues such as NFL, MLB, NBA, NHL, soccer leagues including the English Premier League, La Liga, Serie A, Bundesliga, Ligue 1, and MLS, and motorsports including Formula 1 and NASCAR. The authentication system 100 may also be applied to corporate brands requiring counterfeit protection.

With continued reference to FIG. 1, the authentication system 100 may include excitation sources 102, an authentication material 112, a detector 122, and a processor 124. The excitation sources 102 may be configured to emit light at predetermined wavelengths to excite the authentication material 112. The authentication material 112 may contain photoluminescent components that emit light having predetermined emission characteristics when excited by the excitation sources 102. The detector 122 may be configured to capture light emitted from the authentication material 112. The processor 124 may be operably coupled to the detector 122 and may be configured to receive information from the detector 122 and determine authenticity of an article based on emission characteristics of the captured light.

The authentication system 100 may be configured to authenticate a variety of articles. Example articles may include jerseys, hats, and textiles associated with sports teams or corporate brands. Example articles may also include hangtags and packaging for merchandise and branded products. The authentication system 100 may further be applied to collectible items, corporate identity badges, and event credentials. The authentication material 112 may be disposed on or embedded within such articles to enable verification of authenticity through analysis of emission responses captured by the detector 122 and processed by the processor 124.

The excitation sources 102 may include at least two excitation sources configured to emit light at different wavelength ranges to excite the authentication material 112. The excitation sources 102 may include an ultraviolet (UV) excitation source and an infrared (IR) excitation source.

A UV source 104 (e.g., a UV LED or laser diode) may be configured to emit a UV wavelength 108 (e.g., one or more wavelengths from about 280 nm to about 400 nm) directed toward the authentication material 112. The UV wavelengths preferably include wavelengths in the UVA wavelength range (e.g., about 315 nm to about 400 nm). The UV wavelengths emitted are preferably not broadband emissions—they are preferably emitting in a narrow band of emissions (e.g., having full width half maximum (FWHM) values of no more than ±40 nm, ±30 nm, ±20 nm, ±15 nm, ±10 nm, preferably ±5 nm, or more preferably ±1 nm) around each of the primary wavelengths (e.g., the wavelengths having the maximum intensity). For example, if the UV source(s) emit wavelengths targeting 380 nm, the emissions may preferably have half-maximum wavelengths of 379-381 nm (380 nm±1 nm). Narrower FWHM ranges are preferred.

An IR source 106 (e.g., an IR LED or laser diode) may be configured to emit an IR wavelength 110 (e.g., one or more wavelengths from about 700 nm to about 1 mm) directed toward the authentication material 112. The IR wavelengths preferably include wavelengths in the near infrared (NIR) range (e.g., about 700 nm to about 1.4 μm). The IR wavelengths emitted are preferably not broadband emissions—they are preferably emitting in a narrow band of emissions (e.g., having full width half maximum (FWHM) values of no more than ±40 nm, ±30 nm, ±20 nm, ±15 nm, ±10 nm, preferably ±5 nm, or more preferably ±1 nm) around each of the primary wavelengths (e.g., the wavelengths having the maximum intensity). For example, if the IR source(s) emit wavelengths targeting 940 nm and 980 nm, the emissions may preferably have half-maximum wavelengths of 939-941 nm (940±1 nm) and 979-981 nm (980 nm±1 nm). Narrower FWHM ranges are preferred.

In some implementations, the UV source 104 may include a UV LED or laser diode configured to emit a primary wavelength of approximately 350 nm-380 nm. In some cases, the UV source 104 may include a UV LED or laser diode configured to emit a wavelength of light approximately 280 nm light. The UV source 104 may be configured to emit at both approximately 280 nm and approximately 365 nm wavelengths to provide flexibility in exciting different phosphor compositions within the authentication material 112.

The IR source 106 may include VCSELs or other laser sources. The IR source 106 may include a first IR excitation source configured to emit approximately 800 nm light and a second IR excitation source configured to emit approximately 940 nm light. In some cases, the IR source 106 may include a dual VCSEL system with both 800 nm and 940 nm emission capabilities.

Dual-wavelength excitation using 800 nm and 940 nm may enable fine color control by selectively exciting different phosphors within the authentication material 112. Lower 800 nm excitation power may favor blue emission from phosphors within the authentication material 112. Higher 940 nm excitation power may boost green and red emission from phosphors within the authentication material 112. The dual VCSEL system with 800 nm and 940 nm may dynamically adjust color output by selectively exciting phosphors at different power levels and wavelength combinations. The processor 124 may control the excitation sources 102 to modulate excitation power and wavelength selection during authentication operations, enabling the detector 122 to capture emission responses under varying excitation conditions.

The authentication material 112 may be disposed on or in an article to enable verification of authenticity. As described previously, the authentication material 112 may contain photoluminescent components that emit light having predetermined emission characteristics when excited by the excitation sources 102. The authentication material 112 may be configured as phosphor-based inks, coatings, or printing materials. In some cases, the authentication material 112 may be a polymer additive, textile additive, film, or laminate. The authentication material 112 may be embedded in a textile, printed on packaging, or disposed on a hangtag. Phosphor layers or blends may be pre-mixed into an ink or film for application to articles.

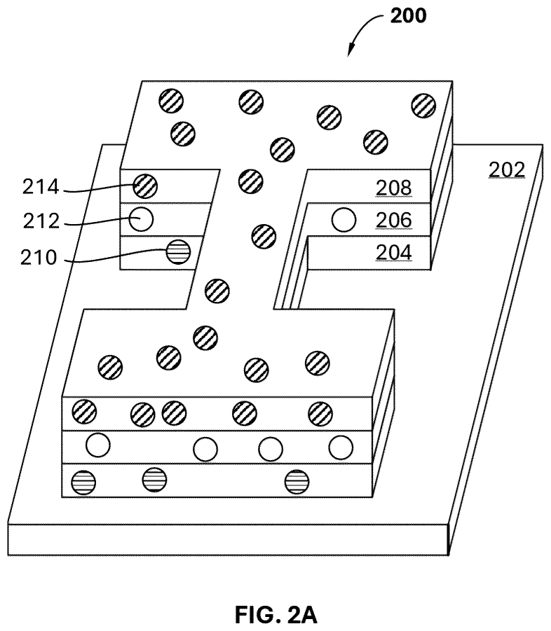

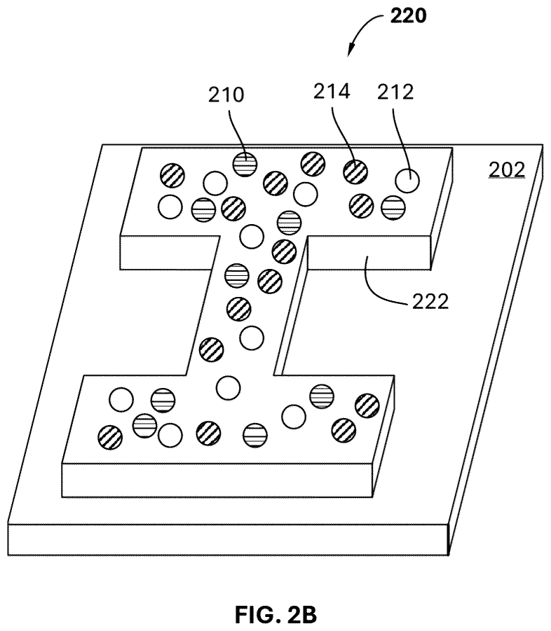

Referring to FIG. 2A, a layered authentication material 200 may include a substrate 202 that provides a base structure for supporting multiple functional layers. The substrate 202 may be a portion of an article such as a hangtag, packaging material, textile, or identity document. Disposed on the substrate 202 may be three distinct layers arranged in a stacked configuration: an overt layer 204, a covert layer 206, and a forensic layer 208.

With continued reference to FIG. 2A, the overt layer 204 may be positioned adjacent to the substrate 202 and may contain first phosphor particles 210. The overt layer 204 may be visible to a user under ambient light or UV excitation. The overt layer 204 may provide an overt emission feature that enables consumer-level verification of authenticity through visible emission responses when excited by the UV source 104.

The covert layer 206 may be positioned above the overt layer 204 and may contain second phosphor particles 212. The covert layer 206 may be visible under IR excitation or may be detectable with a filter or sensor. The covert layer 206 may provide a covert emission feature that enables verification through emission responses that are not readily apparent without appropriate excitation from the IR source 106 or detection equipment. The authentication material 112 may include both the overt emission feature provided by the overt layer 204 and the covert emission feature provided by the covert layer 206.

The covert layer may have phosphors that are randomly distributed in the covert layer. The phosphors may be homogeneously distributed in the covert layer (or on the substrate surface). The phosphors may be heterogeneously distributed in the covert layer (or on the substrate surface).

The forensic layer 208 may be positioned above the covert layer 206 and may contain third phosphor particles 214. The forensic layer 208 may contain forensic markers configured to emit signals distinct from brand-color emissions of the overt layer 204 and the covert layer 206. The forensic layer 208 may enable forensic-level analysis using specialized equipment.

The forensic layer may have phosphors that are randomly distributed in the forensic layer. The phosphors may be homogeneously distributed in the forensic layer (or on the substrate surface). The phosphors may be heterogeneously distributed in the forensic layer (or on the substrate surface).

Referring to FIG. 2B, an authentication material 220 may provide an alternative configuration where multiple types of phosphor particles are intermixed rather than arranged in separate discrete layers. The authentication material 220 may include a combined layer 222 disposed on the substrate 202. The combined layer 222 may contain the first phosphor particles 210, the second phosphor particles 212, and the third phosphor particles 214 distributed throughout the combined layer 222. The blended arrangement of the first phosphor particles 210, the second phosphor particles 212, and the third phosphor particles 214 within the combined layer 222 may allow the authentication material 220 to produce emission responses from multiple phosphor types when excited by the excitation sources 102.

In some implementations, the first, second, and third phosphor particles may be, independently, homogeneously or heterogeneously distributed on the substrate surface. In some implementations, the first, second, and third phosphor particles may be, independently, randomly distributed on the substrate surface.

The authentication material 112 may include phosphors 114 configured to emit light at predetermined wavelengths when excited by the excitation sources 102. The phosphors 114 may include at least one upconverting phosphor 116 and at least one downconverting phosphor 118. The upconverting phosphor 116 may absorb longer wavelength excitation from the IR source 106 and emit shorter wavelength light as an emitted wavelength 120. The downconverting phosphor 118 may absorb shorter wavelength excitation from the UV source 104 and emit longer wavelength light as the emitted wavelength 120. The authentication material 112 may include two or more phosphors to provide multi-dimensional emission signatures for authentication verification. The upconverting phosphor 116 may include IR upconverting phosphor compositions that absorb IR excitation at approximately 800 nm or 940 nm and emit visible light. IR upconverting phosphors may include NaYF₄ doped with Yb³⁺ and Tm³⁺ for blue emission at approximately 450-480 nm. IR upconverting phosphors may include NaYF₄ doped with Yb³⁺ and Er³⁺ for green emission at approximately 540 nm. IR upconverting phosphors may include NaYF₄ doped with Yb³⁺ and Ho³⁺ for red emission at approximately 650-660 nm. IR upconverting phosphors may include Y₂O₃ doped with Yb³⁺ and Er³⁺ for stronger red emission. IR upconverting phosphors may include NaYF₄ doped with Yb³⁺, Tm³⁺, and Er³⁺ for white or balanced color emission covering blue, green, and red wavelengths.

The downconverting phosphor 118 may include UV downconverting phosphor compositions that absorb UV excitation at approximately 254 nm, 302 nm, or 365 nm and emit visible light. UV downconverting phosphors may include BaMgAl₁₀O₁₇:Eu²⁺ for blue emission at approximately 450-460 nm. UV downconverting phosphors may include Y₂O₂S:Eu³⁺ for red emission at approximately 620-660 nm. UV downconverting phosphors may include Zn₂SiO₄:Mn²⁺, also known as Willemite, for green emission at approximately 525-540 nm. UV downconverting phosphors may include Y₂O₃:Eu³⁺ for emission at approximately 610 nm. UV downconverting phosphors may include Ca₅(PO₄)₃(F,Cl):Sb³⁺, Mn²⁺ apatite-based phosphor for warm white emission providing a full spectrum blend.

The phosphors 114 may be blended to match brand chromaticity if a single phosphor cannot reach the desired chromaticity. In some cases, the colors may be matched by an exact phosphor in a single crystal composition. In other cases, additional phosphors may be added to match the exact chromaticity through blending. Color tuning may be achieved by adjusting excitation power, phosphor doping ratio, and mixture ratio. Adjusting the concentration and excitation intensity of each phosphor may allow mixing of blue, green, and red emissions to achieve any color, including whites and pastels.

Combining IR and UV phosphors within the authentication material 112 may allow upconversion for covert security features and downconversion for overt high-brightness applications. The upconverting phosphor 116 may provide covert security features that are detectable under IR excitation from the IR source 106. The downconverting phosphor 118 may provide overt security features that are visible under UV excitation from the UV source 104. Simultaneous IR and UV excitation may enable advanced anti-counterfeit security and hidden color-shifting features. The authentication material 112 may include at least one upconverting phosphor and at least one downconverting phosphor to provide both covert and overt emission responses for multi-level authentication verification.

The authentication material may further comprise a forensic nanocrystal marker configured to emit a signal distinct from a brand-color emission signal. The forensic nanocrystal markers may be substantially uniform, monodisperse phosphors. The substantially uniform, monodisperse nature of the forensic nanocrystal markers may provide consistent emission characteristics that enable reliable forensic-level verification.

The forensic nanocrystal marker may emit in a distinct band that does not interfere with brand color emission. For example, the forensic nanocrystal marker may emit near 980 nm, which may be outside the visible spectrum and separate from the visible brand-color emissions produced by the upconverting and downconverting phosphors configured to match brand chromaticity.

The forensic nanocrystal marker may be excited at a different wavelength than the brand color phosphors. In some cases, the forensic nanocrystal marker may be configured to absorb 940 nm light and emit at 980 nm as a downconverting phosphor. In other cases, the forensic nanocrystal marker may be configured to absorb 940 nm light and emit at 850 nm as an upconverting phosphor. The forensic nanocrystal markers may also be configured to be excited at 980 nm and emit at any detectable wavelength including UV, visible, or IR wavelengths. The flexibility in excitation and emission wavelength configurations may allow the forensic nanocrystal markers to be tailored for specific authentication applications while maintaining separation from the brand-color emission signals produced by the phosphors configured to match team or corporate brand colors.

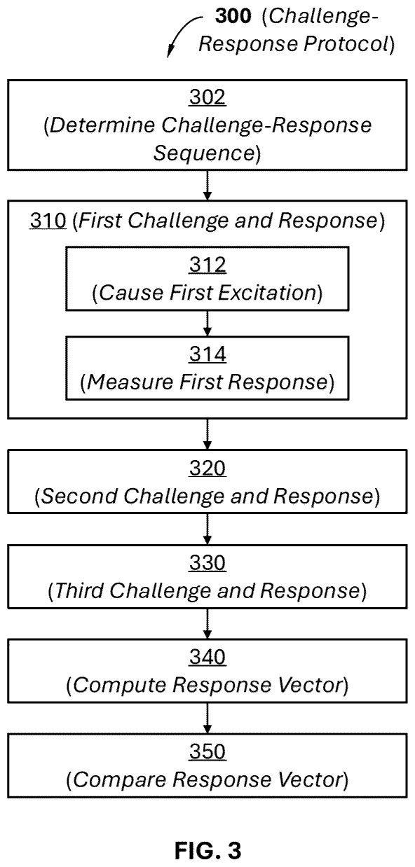

Referring to FIG. 3, a process 300 may provide a challenge-response excitation protocol for authenticating an article bearing the authentication material 112. The process 300 may employ multiple excitation wavelengths and corresponding response measurements to generate a response vector for authentication verification. The challenge-response excitation sequence may comprise excitation at two or more different wavelengths, thereby increasing resistance to spoofing by requiring counterfeiters to replicate responses across multiple excitation conditions.

The process 300 may begin at a step 302, where a challenge-response sequence may be determined. The challenge-response sequence determined at the step 302 may be randomized or pseudo-randomized. The randomization or pseudo-randomization of the challenge-response sequence may increase security by preventing predictable excitation patterns that could be anticipated and spoofed by counterfeiters.

With continued reference to FIG. 3, the process 300 may proceed to a step 310, which may encompass a first challenge and response. Within the step 310, a step 312 may involve causing a first excitation of the authentication material 112. As one example, the first excitation at the step 312 may be performed using the UV source 104 to emit the UV wavelength 108 toward the authentication material 112. Following the step 312, a step 314 may involve measuring a first response from the authentication material 112. The first response measured at the step 314 may be captured by the detector 122 and may include emission characteristics such as chromaticity, spectral profile, and temporal behavior (including, e.g., rise and/or decay times) of the emitted wavelength 120 produced by the phosphors 114 in response to the first excitation.

After completing the first challenge and response in the step 310, the process 300 may move to a step 320, where a second challenge and response may be performed. The second challenge and response at the step 320 may involve causing a second excitation of the authentication material 112 using the IR source 106 at a first wavelength, such as approximately 800 nm, and measuring a corresponding second response. The process 300 may then continue to a step 330, where a third challenge and response may be performed. The third challenge and response at the step 330 may involve causing a third excitation of the authentication material 112 using the IR source 106 at a second wavelength, such as approximately 940 nm, and measuring a corresponding third response. The challenge-response excitation sequence may thus comprise excitation using the UV excitation source, the IR excitation source at a first wavelength, and the IR excitation source at a second wavelength.

In some implementations, such as if the excitation wavelengths and emission wavelengths of the various phosphor materials do not overlap, two or more of the challenge-response steps may be performed simultaneously.

Following completion of the challenge-response sequences in the steps 310, 320, and 330, the process 300 may proceed to a step 340, where a response vector may be computed based on the measured responses from the multiple challenge-response sequences. The response vector computed at the step 340 may include data representing the emission characteristics captured during each of the first, second, and third challenge-response sequences. The process 300 may then move to a step 350, where the computed response vector may be compared to an expected response vector to determine authenticity. The processor 124 may verify whether the observed response vector matches the expected response vector. The expected response vector may correspond to stored reference values associated with a genuine article bearing the authentication material 112 with the phosphors 114 configured to emit brand-specific colors.

In some implementations, a single response vector is created that includes information from all of the challenge-response steps. In some implementations, a single response vector is created for each challenge-response step.

The processor 124 may be configured to authenticate the article using the challenge-response excitation sequence comprising excitation at two or more different wavelengths. As described previously, exciting the authentication material 112 may comprise performing the challenge-response excitation sequence using two or more excitation wavelengths. The sequential nature of the challenge-response sequences in the steps 310, 320, and 330 may enable the authentication system 100 to capture multiple emission characteristics from the authentication material 112 under different excitation conditions, providing multi-factor authentication that may be difficult to replicate without access to the precise phosphor compositions and dopant concentrations used in the authentication material 112.

In some implementations, the authentication may occur after all challenge-response steps are completed. In some implementations, an authentication may occur after each step (e.g., authentication after the first challenge-response step, and if that passes, moving to the second challenge-response step, etc.).

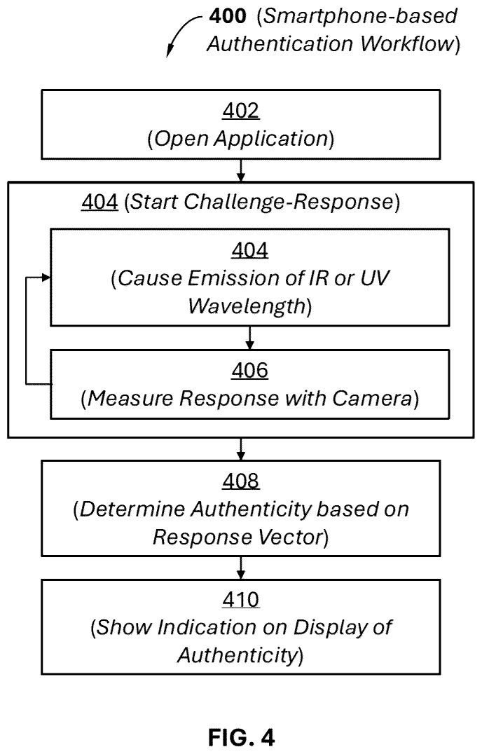

Referring to FIG. 4, a method 400 may provide a smartphone-based authentication workflow for authenticating an article bearing the authentication material 112. The method 400 may enable consumer-level verification of merchandise or branded products using a smartphone device with an associated application.

The method 400 may begin at a step 402, where a user may open an application on a smartphone device. The application opened at the step 402 may be configured to control excitation sources and capture emission responses from the authentication material 112 for authentication verification.

With continued reference to FIG. 4, the method 400 may proceed to a step 404, which may initiate a challenge-response sequence. At the step 404, the system may cause emission of IR or UV wavelength light to excite the authentication material 112. The challenge-response sequence initiated at the step 404 may employ the UV wavelength 108 from the UV source 104 and the IR wavelength 110 from the IR source 106 to excite the phosphors 114 within the authentication material 112. The smartphone-based authentication may use an attachment including excitation sources and filters. The attachment may include the excitation sources 102 configured to emit the UV wavelength 108 and the IR wavelength 110 toward the authentication material 112.

The method 400 may continue to a step 406, where the response from the authentication material 112 may be measured with a camera, such as a smartphone camera. The detector 122 may include a smartphone camera configured to capture the emitted wavelength 120 produced by the phosphors 114 in response to excitation at the step 404. A smartphone camera with one or more filters may approximate spectral response of the emitted light. The one or more filters may be included in the attachment to enable the smartphone camera to capture emission characteristics including chromaticity response and spectral response of the emitted wavelength 120.

The method 400 may then move to a step 408, where authenticity of the article may be determined based on a response vector computed from the measured emissions. The processor 124 may compute the response vector from the emission characteristics captured by the smartphone camera at the step 406. The response vector may include chromaticity response, spectral response, and temporal response characteristics of the emitted light. The processor 124 may compare the computed response vector to stored reference values to determine whether the article bearing the authentication material 112 may be authentic.

The method 400 may conclude at a step 410, where an indication of authenticity may be shown on a display of the smartphone device. The indication shown at the step 410 may include a pass or fail result and may optionally include a confidence value associated with the authentication determination made at the step 408. The method 400 may provide a consumer-level verification workflow that enables users to authenticate merchandise or branded products using a smartphone with the associated application and the attachment including the excitation sources and filters.

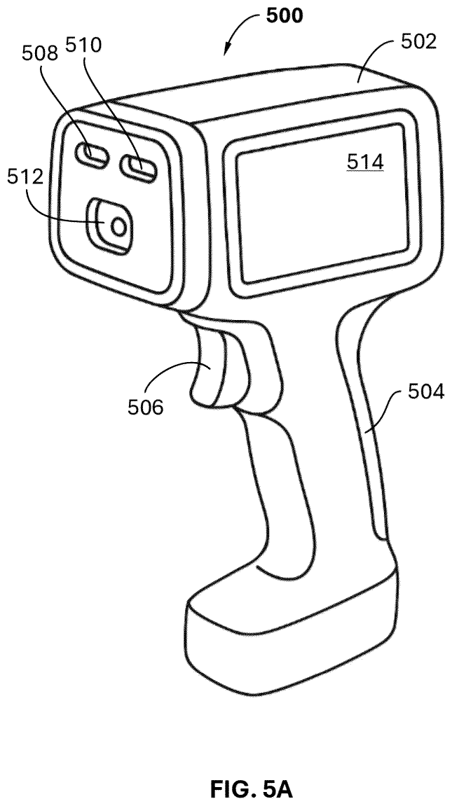

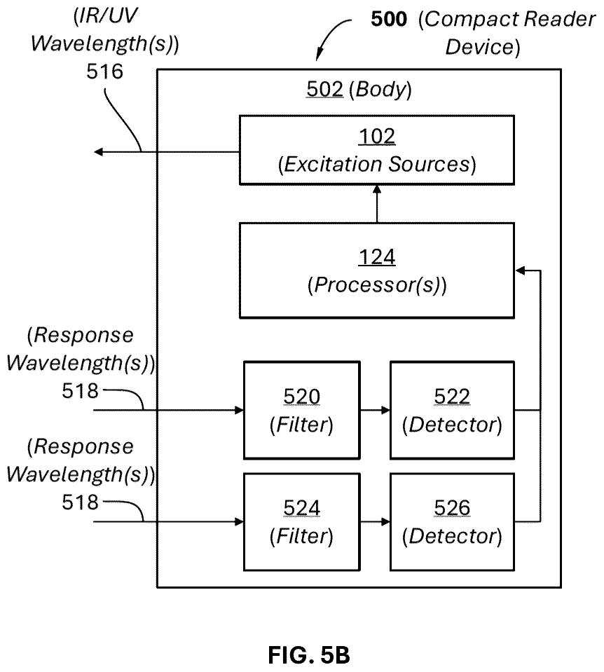

Referring to FIG. 5A, a compact reader device 500 may provide a dedicated authentication device for verifying articles bearing the authentication material 112. The compact reader device 500 may include a body 502 and a handle 504 extending from the body 502. The handle 504 may be configured to be gripped by a user during operation of the compact reader device 500. A trigger 506 may be positioned on the handle 504 proximate to the body 502. The trigger 506 may enable user activation of the compact reader device 500 to initiate an authentication operation.

With continued reference to FIG. 5A, the body 502 may include multiple ports on a front face. A first emission port 508 and a second emission port 510 may be positioned on the front face of the body 502. The emission port 508 and the emission port 510 may be configured to emit excitation light toward the authentication material 112 during an authentication operation. A detection port 512 may also be positioned on the front face of the body 502. The detection port 512 may be configured to receive emitted light from the authentication material 112 in response to excitation. A display 514 may be positioned on a side surface of the body 502. The display 514 may be configured to present information to a user, such as authentication results, status indicators, or other operational data.

Referring to FIG. 5B, the body 502 may contain the excitation sources 102 and the processor 124. The excitation sources 102 may be operably coupled to the processor 124, which may control operation of the excitation sources 102. The excitation sources 102 may emit excitation light through the emission port 508 and the emission port 510 toward the authentication material 112. The processor 124 may control the excitation sequence from the excitation sources 102 to implement the challenge-response excitation protocol described previously with reference to FIG. 3.

With continued reference to FIG. 5B, the compact reader device 500 may include detection channels for receiving and analyzing response wavelengths from the authentication material 112. The detector 122 may be configured to detect light emitted from the authentication material 112 in response to excitation by the UV source 104 and the IR source 106 within the excitation sources 102. The detector 122 may include one or more photodiodes and one or more optical filters. The one or more optical filters may pass selected wavelengths of the emitted light to the one or more photodiodes for detection. The detector 122 may include a first detection channel having a first filter and a first photodiode, and a second detection channel having a second filter and a second photodiode. The dual detection channel configuration may enable the compact reader device 500 to simultaneously detect and analyze multiple wavelength ranges of the emission responses from the authentication material 112.

The detector 122 may include a multispectral sensor or a compact spectrometer for spectral response measurement. A fluorimeter or camera sensor may read emission spectrum and auto-adjust IR power from the excitation sources 102. The processor 124 may receive detection signals from the detector 122 and may process the detected signals to compute authentication features including chromaticity response, spectral response, and temporal response of the emitted light. The processor 124 may be configured to compute authenticity scores based on the computed authentication features. As described previously, detecting emitted light from the authentication material 112 using the detector 122 may enable the processor 124 to determine authenticity of an article based on emission characteristics of the captured light.

The processor 124 may be operably coupled to the detector 122 and may be configured to determine authenticity of the article based on at least two of chromaticity response of the emitted light, spectral response of the emitted light, and temporal response of the emitted light. The processor 124 may receive emission data captured by the detector 122 and may analyze the emission data to extract multiple authentication features for comparison against stored reference values.

The chromaticity response may be defined in terms of CIE 1931 x, y coordinates. The chromaticity response may also be defined in terms of CIE 1976 u′v′ coordinates. The chromaticity response may further be defined in terms of CIELAB values. The processor 124 may be configured to determine authenticity based on whether the chromaticity response matches a predetermined brand chromaticity within a tolerance threshold. The tolerance threshold may be expressed as a ΔE threshold in CIELAB color space. The tolerance threshold for chromaticity matching may be ΔE less than 5 in CIELAB color space. The tolerance threshold may be ΔE less than 3 in CIELAB color space. The tolerance threshold may be ΔE less than 2 in CIELAB color space. The processor 124 may compare an observed chromaticity of the emitted light to the predetermined brand chromaticity and may determine that the chromaticity response matches when the ΔE value falls within the tolerance threshold.

The spectral response may include one or more emission peaks produced by the phosphors within the authentication material when excited by the excitation sources. The spectral response may include relative peak ratios representing intensity relationships between multiple emission peaks. The spectral response may include spectral profile shape characterizing the overall distribution of emitted light across wavelengths. The detector 122 may include a multispectral sensor configured to capture spectral information across multiple wavelength bands. The detector 122 may include a compact spectrometer configured to measure the spectral profile of the emitted light. The processor 124 may analyze the spectral response to determine whether the emission peaks, relative peak ratios, and spectral profile shape match stored reference spectral characteristics associated with authentic articles.

The temporal response may include a luminescence decay lifetime characterizing how quickly the emitted light intensity decreases after excitation ceases. The processor 124 may be configured to determine authenticity based on whether the luminescence decay lifetime matches a stored reference lifetime. The temporal response may also include rise time characterizing how quickly the emitted light intensity increases when excitation begins. The temporal response may include persistence characterizing the duration over which detectable emission continues after excitation ends. The temporal response may include time-gated emission behavior characterizing emission intensity measured during specific time windows relative to excitation pulses. The temporal response may be difficult to counterfeit because the temporal response depends on material composition, dopant concentrations, and crystal structure of the phosphors within the authentication material.

As described previously, computing at least two authentication features including a chromaticity feature and a temporal feature may enable the processor 124 to perform multi-factor authentication. The processor 124 may compute the chromaticity feature from the chromaticity response of the emitted light captured by the detector 122. The processor 124 may compute the temporal feature from the temporal response including the luminescence decay lifetime of the emitted light. Determining whether the article may be authentic may be based on a comparison of the at least two authentication features to stored reference values. The stored reference values may correspond to emission characteristics of authentic articles bearing authentication material with phosphors configured to emit brand-specific colors. The processor 124 may compare the computed chromaticity feature and the computed temporal feature to the stored reference values and may output an authentication determination indicating whether the article may be authentic based on the comparison results.

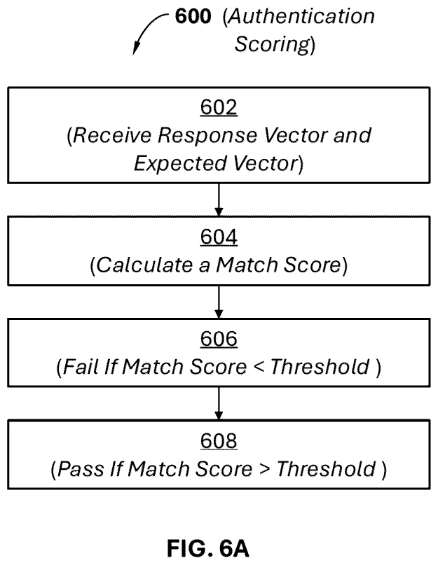

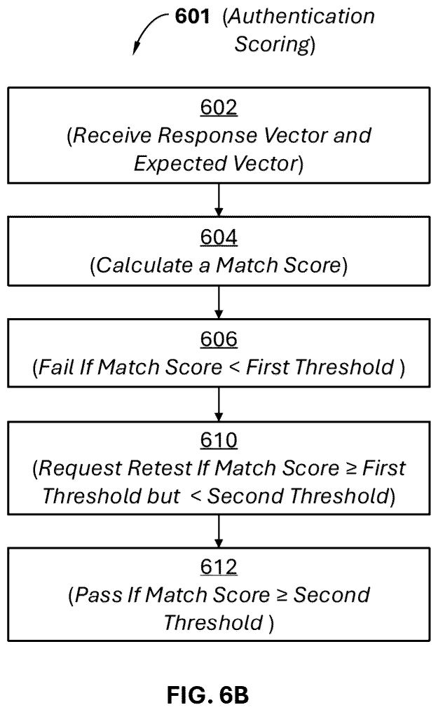

Referring to FIG. 6A, a method 600 may provide an authentication scoring approach for determining authenticity of an article bearing the authentication material 112. The method 600 may begin at a step 602, where a response vector and an expected vector may be received. The response vector received at the step 602 may correspond to measured emission characteristics from the authentication material 112 captured by the detector 122. The expected vector received at the step 602 may correspond to stored reference values associated with a genuine article bearing the authentication material 112 with the phosphors 114 configured to emit brand-specific colors.

With continued reference to FIG. 6A, the method 600 may proceed to a step 604, where a match score may be calculated. The match score calculated at the step 604 may be based on a comparison between the response vector and the expected vector. The processor 124 may compute an authentication score based on various metrics. The metrics may include a ColorMatch metric representing chromaticity matching between the response vector and the expected vector. The metrics may include a SpectralMatch metric representing spectral profile matching between the response vector and the expected vector. The metrics may include a LifetimeMatch metric representing temporal decay lifetime matching between the response vector and the expected vector. The metrics may include a ChallengeMatch metric representing challenge-response sequence matching between the response vector and the expected vector. The overall match score may be computed as, e.g., a weighted sum of the various metrics. For example, using the four scores mentioned here, a score could be calculated as, e.g., Score=weight 1×ColorMatch+weight 2×SpectralMatch+weight 3×Lifetime Match+weight 4×ChallengeMatch. In a preferred embodiment, the weights are selected such that a perfect match on all metrics results in a score of 1 (or 100%).

The method 600 may then move to a step 606, where the processor 124 may determine whether the match score calculated at the step 604 may be less than a threshold. In some implementations, where scores range from 0-100%, the threshold here may be, e.g., at least 50%, at least 60%, at least 70%, at least 80%, at least 90%, or at least 95%. As will be understood, higher thresholds reduce risk of false positives (e.g., that a fake product will be deemed authentic), but increase the risk of false negatives (e.g., that an authentic product will not be deemed authentic), especially if the products are expected to be tested or checked in non-ideal conditions.

If the match score is less than the threshold, the authentication may fail, indicating that the article may not be authentic. Otherwise, the method 600 may proceed to a step 608, where the processor 124 may determine whether the match score may be greater than the threshold. If the match score may be greater than the threshold, the authentication may pass, indicating that the article may be authentic. The processor 124 may output PASS or FAIL (or similar signals to a user) based on the comparison of the match score to the threshold. The processor 124 may optionally output a confidence value associated with the authentication determination.

Referring to FIG. 6B, a process 601 may provide a dual-threshold authentication scoring approach that may be more forgiving with regards to variation that may occur in imperfect test conditions. The process 601 may begin at the step 602, where the response vector and the expected vector may be received. The process 601 may then proceed to the step 604, where the match score may be calculated based on the comparison between the response vector and the expected vector using, e.g., weighted metrics as disclosed herein.

With continued reference to FIG. 6B, the process 601 may move to the step 606, where the processor 124 may determine whether the match score is less than a first threshold (e.g., 50%, 60%, etc.). If the match score is less than the first threshold, the authentication may fail, indicating that the article may not be authentic. The process 601 may proceed to a step 610, where the processor 124 may determine whether the match score is greater than or equal to the first threshold but less than a second threshold. If the match score is between the first threshold and the second threshold, the processor 124 may signal that a retest is required. The retest may involve performing additional excitation sequences or measurements to obtain more data before making a final determination.

In some cases, a retest may simply involve repeating this same process. In some implementations, a retest may instead follow a process akin to that shown in FIG. 6A, where there are only pass/fail ratings, and no further retesting can be done. This may prevent an endless loop of retesting.

If the match score is greater than or equal to the second threshold, the process 601 may proceed to a step 612, where the authentication may pass, indicating that the article may be authentic.

The dual-threshold approach of the process 601 may provide three possible outcomes: fail, retest, or pass. The dual-threshold approach may allow the processor 124 to handle borderline cases by requesting additional verification rather than making a potentially incorrect determination based on a single measurement. The processor 124 may output PASS, FAIL, or RETEST based on the comparison of the match score to the first threshold and the second threshold. The processor 124 may optionally output a confidence value associated with the authentication determination made using the dual-threshold approach.

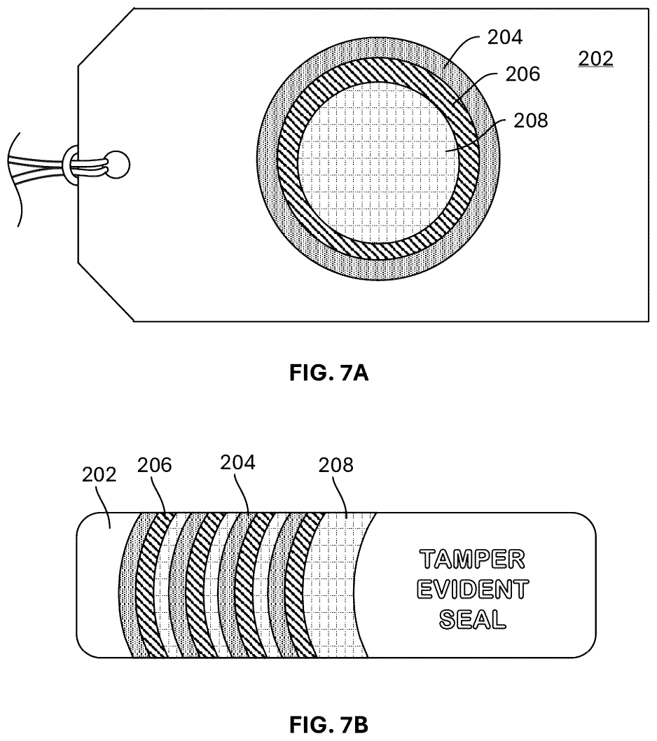

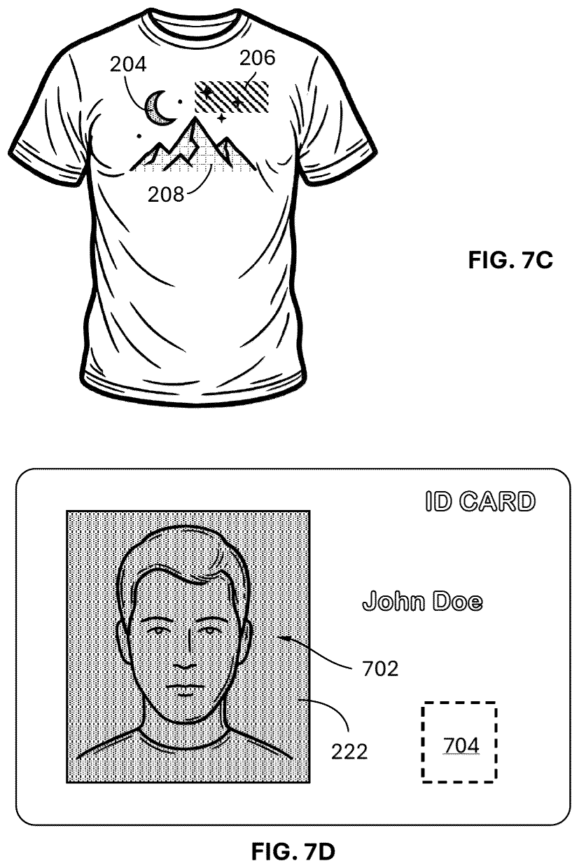

Referring to FIG. 7A, the authentication system 100 may be applied to a variety of articles including hangtags. FIG. 7A illustrates a front view of an article configured with the layered authentication material 200. The article may be a hangtag with a string attachment. The hangtag may include a circular authentication region positioned on the substrate 202. The circular authentication region may comprise multiple concentric layers arranged from the center outward. The forensic layer 208 may be positioned at the center of the circular region. The covert layer 206 may surround the forensic layer 208. The overt layer 204 may form the outermost ring of the authentication region. The concentric arrangement of the overt layer 204, the covert layer 206, and the forensic layer 208 on the substrate 202 may provide a compact authentication feature suitable for application to hangtags, packaging, and other branded merchandise.

Referring to FIG. 7B, the authentication system 100 may be applied to tamper evident seals. FIG. 7B illustrates a section view of a tamper evident seal incorporating the layered authentication material 200. The tamper evident seal may include the substrate 202 that provides a base layer for the authentication components. Disposed on the substrate 202 may be multiple authentication layers arranged in an overlapping configuration. The overt layer 204 may be visible and may contain phosphor particles that emit detectable light under appropriate excitation conditions from the excitation sources 102. The covert layer 206 may be positioned adjacent to the overt layer 204 and may contain phosphor materials that are visible under specific excitation conditions such as infrared excitation from the IR source 106 or when detected with appropriate filters or sensors. The forensic layer 208 may also be incorporated into the layered structure and may contain forensic markers configured to emit signals distinct from the brand-color emissions of the overt layer 204 and the covert layer 206. The layered configuration of the overt layer 204, the covert layer 206, and the forensic layer 208 on the substrate 202 may enable multi-level authentication verification ranging from consumer-level overt verification to forensic-level analysis.

Referring to FIG. 7C, the authentication system 100 may be applied to textile articles. FIG. 7C illustrates a front view of a textile article in the form of a t-shirt with authentication material applied thereto. The t-shirt may include a graphic design on the front portion that incorporates multiple authentication layers. The overt layer 204 may be visible as a crescent moon shape positioned on the left side of the design. The covert layer 206 may appear as a hatched rectangular region in the upper right portion of the design, representing an area that may be visible under specific excitation conditions from the excitation sources 102. The forensic layer 208 may be depicted as a cross-hatched mountain shape in the lower central portion of the design. The overt layer 204, the covert layer 206, and the forensic layer 208 may be integrated into the decorative graphic, demonstrating how the phosphor-based authentication system 100 may be incorporated into textile products such as sports merchandise or branded apparel. The article may be sports merchandise or branded corporate merchandise.

Referring to FIG. 7D, the authentication system 100 may be applied to identity cards. FIG. 7D illustrates a front view of an identity card incorporating the authentication material 220. The identity card may have a rectangular shape with rounded corners. The left portion of the identity card may feature an image 702 depicting a stylized portrait within a bordered rectangular region. The image 702 may contain or may be printed with authentication material. The combined layer 222 may be disposed on or within the identity card substrate. The combined layer 222 may contain multiple types of phosphor particles intermixed within a single layer, enabling multiple authentication responses when excited by the UV source 104 and the IR source 106 within the excitation sources 102. The identity card demonstrates an application of the authentication system 100 where the combined layer 222 may be integrated into the card, enabling verification of the identity document through chromaticity, spectral, and temporal response characteristics of the emitted wavelength 120.

The article may include an identifier selected from the group consisting of a serial number, a QR code, an NFC tag, and an RFID tag. The processor 124 may be configured to associate the identifier with an emission signature. The emission signature may correspond to the chromaticity response, spectral response, and temporal response characteristics of the emitted light produced by the phosphors 114 within the authentication material 112 when excited by the excitation sources 102.

The identifier may be associated with a stored reference emission signature. The association between the identifier and the stored reference emission signature may prevent reuse of authentication materials on counterfeit products. The binding of the identifier to the stored reference emission signature may enable the processor 124 to verify that the authentication material disposed on or in the article corresponds to the specific article identified by the identifier. The authentication system 100 may support chain-of-custody tracking through identifier binding. The processor 124 may track authentication events associated with the identifier over time, enabling verification of the provenance and handling history of the article. As described previously, the article may be sports merchandise or branded corporate merchandise, including jerseys, hats, textiles, hangtags, packaging, collectible items, corporate identity badges, and event credentials.

The processor 124 may be configured to log an authentication event to a blockchain. The blockchain may provide a secure, tamper-proof ledger for recording authentication events associated with articles bearing the authentication material 112. The authentication event logged to the blockchain may include the at least two authentication features computed by the processor 124 during the authentication operation. The at least two authentication features may include the chromaticity feature and the temporal feature as described previously. The authentication event may also include additional authentication features such as the spectral response characteristics of the emitted light captured by the detector 122.

Authentication events logged to the blockchain may include timestamp information indicating when the authentication operation was performed. The timestamp information may enable tracking of when each authentication event occurred for a given article. Authentication events logged to the blockchain may also include location information indicating where the authentication operation was performed. The location information may be obtained from a GPS receiver or other location-determining component associated with the compact reader device 500 or a smartphone device executing the authentication application. The combination of timestamp and location information with the at least two authentication features may provide a comprehensive record of each authentication event.

The processor 124 may interact with a remote processor for logging authentication events. The remote processor may operate the blockchain and may receive authentication event data from the processor 124 over a network connection. The processor 124 may transmit the authentication event data including the at least two authentication features, the timestamp information, and the location information to the remote processor. The remote processor may validate the authentication event data and may record the authentication event to the blockchain. The interaction between the processor 124 and the remote processor may enable centralized management of authentication records while maintaining the distributed, tamper-proof nature of the blockchain.

Logging an authentication event including the at least two authentication features to the blockchain may create an auditable chain of custody for tracking purposes. The auditable chain of custody may enable verification of the provenance and handling history of an article over time. Each authentication event logged to the blockchain may be associated with the identifier of the article, such as the serial number, QR code, NFC tag, or RFID tag as described previously. The processor 124 may track authentication events logged into the blockchain for a given article by querying the blockchain using the identifier. The auditable chain of custody created through blockchain logging may support anti-counterfeiting efforts by enabling detection of anomalous authentication patterns, such as multiple authentication events occurring at geographically distant locations within a short time period, which may indicate the presence of counterfeit articles bearing replicated identifiers.

UV excitation wavelength selection may depend on the specific phosphor compositions within the authentication material and the optical requirements of the detection system. As described previously, UV excitation at approximately 365 nm (UVA) may provide broad excitation suitable for many phosphor compositions and may enable safer handling during authentication operations. Additional UV excitation wavelengths may be employed to accommodate specialty phosphors or to achieve stronger excitation responses.

UV excitation at approximately 302 nm (UVB) may be used for some specialty phosphors that exhibit enhanced absorption or emission characteristics at UVB wavelengths. Certain phosphor compositions may have absorption bands centered near 302 nm that provide more efficient energy transfer compared to UVA excitation. The UVB excitation wavelength may enable authentication of articles bearing specialty phosphors that are less responsive to UVA excitation at 365 nm.

UV excitation at approximately 254 nm (UVC) may provide stronger excitation compared to UVA and UVB wavelengths for certain phosphor compositions. The shorter wavelength of UVC excitation may result in higher photon energy that enables more efficient excitation of phosphors with absorption bands in the deep UV region. However, UV excitation at 254 nm may require quartz optics due to air absorption at UVC wavelengths. Standard glass optics may absorb a substantial portion of UVC light, reducing the excitation intensity reaching the authentication material. Quartz optics may transmit UVC wavelengths with lower absorption losses, enabling effective excitation of the authentication material at 254 nm. The requirement for quartz optics may increase the complexity and cost of authentication systems employing UVC excitation. Authentication systems configured for UVC excitation at 254 nm may incorporate quartz windows, quartz lenses, or other quartz optical components in the excitation path to maintain sufficient excitation intensity at the authentication material.

In some implementations, referring to FIG. 7D, as an alternative to or in addition to the identifier of the article (e.g., in addition to or as a replacement for the NFC tag), companion material 704 (e.g., a code and/or image identifying an expected phosphor patterns, phosphor emissions, or information encoded by the phosphors) may be printed on the substrate. In such implementations, the companion material may allow the article to be at least partially authenticated (and preferably fully authenticated) on-device, e.g., by a mobile device scanning the article, without external communications. In some implementations, the companion material may be placed on the substrate and not overlapping the authentication material. In some implementations, the companion material may overlap the authentication material, provided the companion material is transparent to the wavelengths e mitted by any underlying phosphors. In some implementations, a mobile device may scan both the authentication material as disclosed as well as the companion material, verify authenticity of the authentication material based on the companion material, and then transmit information to a remote server as disclosed herein. In some instances, no further authentication is done remotely. In some implementations, additional authentication occurs remotely. In some cases, the companion material may include an image that maps where the phosphors of, e.g., the covert and/or forensic layers, appear on the article. In some cases, the companion material may include a code (which can be scanned or entered into the mobile device) to provide information about the spectral profile of one or more of the phosphors.

A number of implementations have been described. Nevertheless, it will be understood that various modifications may be made without departing from the spirit and scope of the disclosure. Accordingly, other implementations are within the scope of the following claims.

1. An authentication system, comprising:
at least two excitation sources including an ultraviolet (UV) excitation source and an infrared (IR) excitation source;
an authentication material disposed on or in an article, the authentication material comprising two or more phosphors;
a detector configured to detect light emitted from the authentication material in response to excitation by the UV excitation source and the IR excitation source; and
one or more processors operably coupled to the detector, the one or more processors configured to determine authenticity of the article based on at least two of:
chromaticity response of the emitted light,
spectral response of the emitted light, and
temporal response of the emitted light.

2. The authentication system of claim 1, wherein the authentication material comprises at least one upconverting phosphor and at least one downconverting phosphor.

3. The authentication system of claim 1, wherein the temporal response comprises a luminescence decay lifetime, and the one or more processors are configured to determine authenticity based on whether the luminescence decay lifetime matches a stored reference lifetime.

4. The authentication system of claim 1, wherein the one or more processors are configured to determine authenticity based on whether the chromaticity response matches a predetermined brand chromaticity within a tolerance threshold.

5. The authentication system of claim 4, wherein the tolerance threshold is expressed as a ΔE threshold in CIELAB color space.

6. The authentication system of claim 1, wherein the IR excitation source comprises a first IR excitation source configured to emit approximately 800 nm light and a second IR excitation source configured to emit approximately 940 nm light.

7. The authentication system of claim 1, wherein the UV excitation source comprises a UV LED or laser diode configured to emit approximately 365 nm light.

8. The authentication system of claim 1, wherein the detector comprises a smartphone camera.

9. The authentication system of claim 1, wherein the detector comprises one or more photodiodes and one or more optical filters.

10. The authentication system of claim 1, wherein the one or more processors are configured to authenticate the article using a challenge-response excitation sequence comprising excitation at two or more different wavelengths.

11. The authentication system of claim 10, wherein the challenge-response excitation sequence comprises excitation using the UV excitation source, the IR excitation source at a first wavelength, and the IR excitation source at a second wavelength.

12. The authentication system of claim 1, wherein the authentication material comprises an overt emission feature and a covert emission feature.

13. The authentication system of claim 1, wherein the authentication material further comprises a forensic nanocrystal marker configured to emit a signal distinct from a brand-color emission signal.

14. The authentication system of claim 1, wherein the article includes an identifier selected from the group consisting of a serial number, a QR code, an NFC tag, and an RFID tag, and the one or more processors are configured to associate the identifier with an emission signature.

15. The authentication system of claim 1, wherein the one or more processors are configured to log an authentication event to a blockchain.

16. A method of authenticating an article, comprising:
applying an authentication material comprising two or more phosphors to the article;
exciting the authentication material using an ultraviolet (UV) excitation source and an infrared (IR) excitation source;
detecting emitted light from the authentication material using a detector;
computing at least two authentication features including a chromaticity feature and a temporal feature; and
determining whether the article is authentic based on a comparison of the at least two authentication features to stored reference values.

17. The method of claim 16, further comprising logging an authentication event including the at least two authentication features to a blockchain.

18. The method of claim 16, wherein exciting the authentication material comprises performing a challenge-response excitation sequence using two or more excitation wavelengths.

19. The method of claim 16, wherein the article is sports merchandise or branded corporate merchandise.

20. The method of claim 16, wherein the authentication material is embedded in a textile, printed on packaging, or disposed on a hangtag.
